(19) United States
(12) Patent Application Publication
(10) Pub. No.: US 2024/0329491 A1
(43) Pub. Date: Oct. 3, 2024

(54) REDUCING STRAY LIGHT IN BEAM STEERING SYSTEMS USING POLARIZATION GRATINGS

(71) Applicant: Meadowlark Optics, Inc., Frederick, CO (US)

(72) Inventors: Christopher Hoy, Denver, CO (US); Douglas J. McKnight, Boulder, CO (US); Steven A. Serati, Westminster, CO (US); Kelly Kluttz, Boulder, CO (US)

(21) Appl. No.: 18/365,311

(22) PCT Filed: Feb. 5, 2022
(86) PCT No.: PCT/US2022/015520

§ 371 Date: Aug. 4, 2023

Related U.S. Application Data
(60) Provisional application No. 63/146,047, filed on Feb. 5, 2021.

(51) Int. Cl. G02F 1/29

(52) U.S. Cl. CPC G02F 1/29; G02F 2203/24

(57) ABSTRACT

This disclosure describes systems, methods, and apparatus for reducing stray light in a non-mechanical beam steering or light angle alteration application. A non-mechanical beam steering assembly, including polarization-controlling switches and polarization gratings, can be followed by or preceded by a polarization controller, such as a retarder, and a polarizer, such as a linear polarizer. The polarization controller can convert circularly polarization from the non-mechanical beam steering assembly into linear polarization, and then the polarizer can filter for the desired polarization of light thereby reducing stray or unwanted light.

### CLAIM OF PRIORITY UNDER 35 U.S.C. § 119

The present Application is a National Stage Application based on PCT/US22/15520 entitled “REDUCING STRAY LIGHT IN BEAM STEERING SYSTEMS USING POLARIZATION GRATINGS” filed Feb. 7, 2022 which claims priority to Provisional Application No. 63/146,047 entitled “REDUCING STRAY LIGHT IN BEAM STEERING SYSTEMS USING POLARIZATION GRATINGS” filed Feb. 5, 2021 and assigned to the assignee hereof and hereby expressly incorporated by reference herein.

### FIELD OF THE DISCLOSURE

The present disclosure relates to beam steering and, more particularly, to beam steering using polarization gratings and related methods of operation.

### DESCRIPTION OF RELATED ART

With increasing demands for compact, robust, and/or cost-effective devices for beam steering, Risley Prisms (typically made up of pairs of wedge prisms) have been used for their high degree of accuracy and stability. Their utility, however, may be limited by relatively small deflection angles and/or poor size scaling properties (for example, due to bulky prismatic elements) where wide angles and modest/large apertures are required. Other mechanical methods to steer the light, such as tilting a mirror or gimbal mount, may also present difficulties for many applications due to their size, weight, and/or speed. Non-mechanical (inertialess) beam steering options may also be possible, such as optical-phased-arrays formed by liquid crystal (LC) spatial-light-modulators or electrowetting devices, switchable volume holograms, blazed gratings, birefringent prisms, microlens (lenslet) arrays, and Micro-Electro-Mechanical Systems (MEMs) mirrors. However, many of these applications may be limited by relatively low throughput, high absorption/loss/scattering, small steering range/resolution/aperture, and/or large physical size/weight.

Effective non-mechanical beam steering has previously been described, for instance, in U.S. Pat. Nos. 6,924,923, 8,982,313, and 10,509,296. This type of system comprises, typically, several stages, each comprising a polarization-controlling switch (PCS), such as a liquid crystal cell, to control the polarization of the light passing through it, and one or more polarization grating (PG) steering elements. The polarization gratings output light at a different angle depending on the polarization of incident light. Thus, by adjusting the incident polarization with the liquid crystal cell, the pair of liquid crystal cell and polarization grating form a non-mechanical beam steering stage. By stacking additional stages, one can achieve greater numbers of output angles, and thus greater beam steering precision, as well as wider angles of steering. In general, this type of beam steering system is best thought of as a multilayer “sandwich”, or “stack”, of liquid crystal cells and liquid crystal polarization grating steering elements (i.e., stages) and may be referred to as a liquid crystal polarization grating stack or LCPG stack, a non-mechanical beam steerer (NMBS), or digital beam steering device (DBSD), although other terms can also apply to this type of system. For purposes of this disclosure, the term LCPG stack will be used.

The description of an LCPG stack given above describes light being steered in angle by PGs. It can be readily appreciated that the steering angle can optionally be designed to vary across the aperture of the PG. A specific case of a varying steering angle is given by a PG lens, in which the deflection of the light by the PG creates a focusing or defocusing of the light. In other words, LCPG stacks can be used in place of traditional focusing/defocusing lenses, and “beam steering” for the purposes of this disclosure includes not just redirection of collimated light, but also focusing and defocusing of collimated and non-collimated light. Examples of LCPG stacks with PG lenses are taught in U.S. Pat. Nos. 10,191,911, 10,120,112, and 11,175,508.

Non-mechanical beam steering using LCPG stacks is accompanied by stray light transmitted at undesired angles. This stray light arises when either the diffraction efficiency of a PG or the polarization conversion efficiency of a PCS is less than 100%, as is commonly the case for practical components. It is desirable to provide non-mechanical beam steering with a reduction in stray light over existing technologies.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to some aspects of the disclosure an optical assembly for non-mechanical light angle alteration and filtering of stray light is disclosed. The optical assembly can include a beam steering assembly including a first polarization-controlling switch, a first polarization grating, a second polarization-controlling switch, and a second polarization grating. The optical assembly can also include a first means to control and filter polarization of light entering or leaving the beam steering assembly such that a ratio of emitted light in one angle to emitted light in all other angles of the emitted light is increased.

According to some aspects of the disclosure a method of filtering stray light in a non-mechanical beam steering optical assembly is disclosed. The method can include passing polarized light through a non-mechanical beam steering assembly comprising at least two stages. Optionally, the polarized light can first be passed through a linear polarizer and a retarder before the polarized light pass through the beam steering assembly. Each of the at least two stages can include a polarization-controlling switch (PCS) and a polarization grating (PG). The method can include converting the polarized light from circular to linear polarization after the polarized light leaves the non-mechanical beam steering assembly. The method can further include filtering some but not all linear polarizations of the polarized light after the polarized light is converted to the linear polarization. In some case, the emitted light can be directed to objects, for instance in a LIDAR application, and scattering the polarized light having the linear polarization off of one or more of the objects to form scattered light. The scattered light can be passed back through the non-mechanical beam steering assembly, for instance, to a LIDAR sensor.

According to some aspects of the disclosure another method of filtering stray light in a non-mechanical beam steering optical assembly is disclosed. The method can include filtering light to linearly polarized light and converting the linearly polarized light to circularly polarized light. The method can further include passing the circularly polarized light through a non-mechanical beam steering assembly comprising at least two stages, where each of the two stages including a polarization-controlling switch and a polarization grating.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1A illustrates a system using two pairs of PCS and PGs to deflect a beam of light;

FIG. 1B illustrates the beam steering configuration shown in FIG. 1A, with additional rays drawn that arise from imperfect diffraction efficiency of the PGs;

FIG. 1C illustrates the beam steering configuration shown in FIG. 1A, with additional rays drawn that arise from imperfect polarization control of the PCSs;

FIG. 2A illustrates a beam steering assembly using two pairs of PCSs and PGs to deflect a beam of light, along with a Quarter Wave Plate (QWP) and a linear polarizer (LP), with additional rays drawn that arise from imperfect diffraction efficiency of the PGs;

FIG. 2B illustrates the beam steering assembly of FIG. 2A, with additional rays drawn that arise from imperfect polarization control of the PCSs;

FIG. 3A illustrates a beam steering assembly using two pairs of PCSs and PGs to deflect a beam of light, along with a variable retarder and a linear polarizer (LP), with additional rays drawn that arise from imperfect diffraction efficiency of the PGs;

FIG. 3B illustrates the beam steering assembly of FIG. 3A, with additional rays drawn that arise from imperfect polarization control of the PCSs;

FIG. 4A illustrates a beam steering assembly using two pairs of PCSs and PGs to deflect a beam of light, along with a Quarter Wave Plate (QWP), a polarization rotator, and a linear polarizer (LP), with additional rays drawn that arise from imperfect diffraction efficiency of the PGs; and

FIG. 4B illustrates the beam steering assembly of FIG. 4A, with additional rays drawn that arise from imperfect polarization control of the PCSs.

FIG. 5 presents an example of light returning back through the optical assembly, for instance, in a LIDAR application.

FIG. 6A shows stray light and filtering for a bidirectional system, where the rays shown illustrate stray light filtering in the transmit direction.

FIG. 6B shows stray light and filtering for a bidirectional system, where the rays shown illustrate stray light filtering in the receive direction after scattering of the transmit beam.

FIG. 7A shows a LIDAR application where the optical assembly performs both transmission from the LIDAR source/sensor as well as reception of the returning signal to the LIDAR source/sensor.

FIG. 7B shows an optical assembly performing transmission from a free space optical (FSO) communication terminal as well as reception of a signal in the opposing direction being received by the FSO communication terminal.

FIG. 8 illustrates a method of filtering stray light in a non-mechanical beam steering optical assembly.

FIG. 9 shows a block diagram depicting physical components that may be utilized to realize a controller of a liquid crystal driver and/or heater drive according to an exemplary embodiment.

### DETAILED DESCRIPTION

This disclosure describes systems, methods, and apparatus that reduce undesired stray light from LCPG stacks by converting the circularly-polarized light that exits an LCPG stack to linear polarizations and filtering those polarizations to transmit the desired light while blocking the most intense stray light.

The word “exemplary” is used herein to mean “serving as an example, instance, or illustration.” Any embodiment described herein as “exemplary” is not necessarily to be construed as preferred or advantageous over other embodiments.

For the purposes of this disclosure, a polarization-controlling switch (PCS) is any element that alters polarization (or controls polarization), such as a liquid crystal variable retarder or an electro-optic crystal, to name two non-limiting examples. Control can be possible via application of an electric field, changing temperature, or exposing the material to light, to name three non-limiting examples. A liquid crystal sandwiched between substrates coated with transparent electrodes is one non-limiting example of a PCS.

Since a PCS can rotate polarization it is sometimes referred to as a polarization rotator, and includes any optical component that rotates the axis of linearly polarized light, such as a mechanically rotating retarder, a liquid crystal variable retarder, a liquid crystal exhibiting in-plane switching, an electro-optic crystal, a waveguide, and a twisted-nematic liquid crystal, to list a few non-limiting examples.

Preliminary note: the flowcharts and block diagrams in the following Figures illustrate the architecture, functionality, and operation of possible implementations of systems, methods according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items, and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present. Likewise, when light is received or provided “from” one element, it can be received or provided directly from that element or from an intervening element. On the other hand, when light is received or provided “directly from” one element, there are no intervening elements present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

As used herein, “zero-order” light propagates in a direction substantially parallel to that of the incident light, i.e., at a substantially similar angle of incidence. While this light may be referred to as “on-axis” when the incident light is perpendicular to the LCPG stack, for obliquely incident light, it may be better to refer to zero-order light as that which does not undergo diffraction. For example, in several of the embodiments described in detail below, the incident light is normal to the first polarization grating; thus, “zero-order” light would also propagate substantially normal to the first polarization grating in these embodiments. In contrast, “non-zero-order light”, such as “first-order” light, sees diffraction and propagates obliquely to the incident light.

Polarization gratings according to some embodiments of the present invention may be transparent, thin-film, beam-splitters that alter the local polarization state and propagation direction of light traveling therethrough. In contrast, conventional linear polarizers may operate by permitting light of that polarization state to travel therethrough, but absorbing or redirecting light of other polarization states.

Some embodiments of the present disclosure provide devices that can steer (control) the direction of light passing therethrough. The devices may include at least two stacked polarization gratings and other elements that provide a beam steering assembly with good optical efficiency and size. These devices may also be able to focus or defocus light.

While some embodiments may be described herein as acting on narrowband input light (for example, from a monochromatic laser), it is to be understood that wideband input light may be used in a similar fashion. Likewise, while described herein specifically with reference to visible and infrared light, the disclosure is easily applied to all wavelengths of electromagnetic radiation.

Embodiments of the disclosure are described herein with reference to cross-section illustrations that are schematic illustrations of idealized and simplified embodiments of optical assemblies. As such, variations from the shapes of the illustrations are anticipated in practice. For example, different numbers of polarization-controlling switches (PCS), polarization gratings (PGs), and pairs thereof (“PCS-PG pairs”) can be used to provide additional steering angles, or different orientations of PCS-PG pairs can be used to affect beam steering in higher dimensions, both without departing from the spirit and scope of the disclosure. A PCS-PG pair may also be referred to herein as a “stage.” The optical assemblies may also have different aperture shapes such as circular and square/rectangular, to name two non-limiting examples. Thus, embodiments of the disclosure should not be construed as limited to the particular configurations of LCPG beam steering components illustrated herein but are to include deviations in configuration, for instance, those taught in U.S. Pat. No. 8,982,313, which is incorporated by reference herein in its entirety. Other examples include LCPG stacks with PG lenses configured to focus and defocus light. Accordingly, the regions illustrated in the figures are schematic in nature and their shapes are not intended to illustrate the actual shape of a region of a device and are not intended to limit the scope of the disclosure.

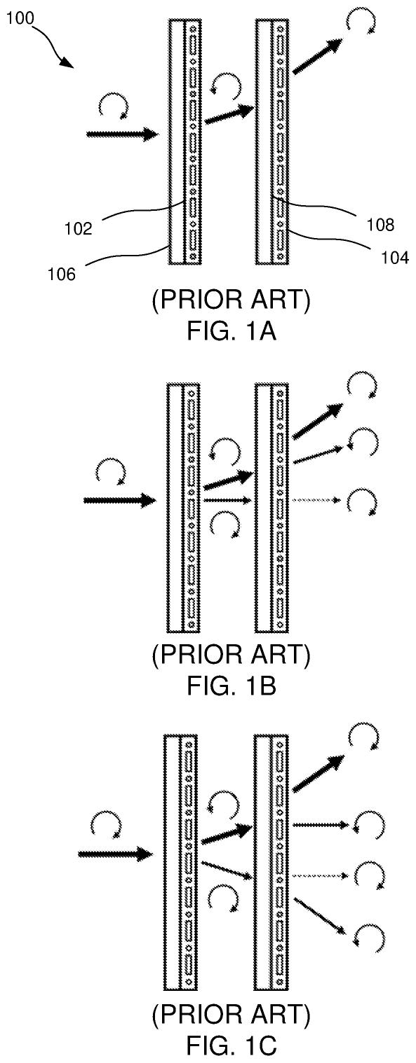

Liquid Crystal Polarization Gratings (LCPG), Cycloidal Diffractive Waveplates (CDW), or geometric phase gratings, use patterned birefringent material to apply a diffractive grating to incident light using geometric phase (see, FIG. 1 of U.S. Pat. No. 8,982,313, for instance). If incident light is right hand circularly polarized (RCP), the grating diffraction angle will have a first sign (i.e., positive or negative), and if the incoming light is left hand circularly polarized (LCP), the grating diffraction angle will have the opposite sign. Thus, by choosing the handedness of polarization of incident light, one can select whether the grating will diffract incident light in a positive or negative angle without any mechanical change to the grating itself-hence the term non-mechanical beam steering. This steering can also be used to achieve focusing or defocusing and thus one may more generally refer to this technology and non-mechanical light angle alteration.

Therefore, a beam steering pair or stage can be formed by combining a PG with a polarization-controlling switch (PCS), such as a liquid crystal variable retarder. The PCS selects the circular polarization handedness incident on the PG and thus the pair can control steering angle. Multiple pairs of PCS and PG can be used in a stack to achieve greater numbers of steering angles. A PCS can include various types of polarization controllers and retarders, which can include birefringent material, such as a crystal, liquid crystal, or polymer, to name three non-limiting examples.

FIG. 1A illustrates how the polarization handedness of the incoming light will determine in which direction the outgoing ray of light is steered and also how the polarization handedness is changed during the diffraction at each PG 102, 104. Circular arrows indicate the handedness of circular polarization as the ray of light progresses through the layers. The line widths of the arrows indicate rough relative magnitudes of energy in each ray in a common use case. In the case shown in FIG. 1A, the beam steering assembly 100 includes two PCS components 106, 108 that may not necessarily be in the same state, i.e., one may be changing the polarization handedness and the other may not.

In practice, undesired rays of light may exit each stage through any combination of imperfect (e.g., non-unity) diffraction efficiency and imperfect PCS polarization control, as shown in FIGS. 1B and 1C, respectively. FIG. 1B shows the optical assembly of FIG. 1A but with additional rays drawn that arise from imperfect diffraction efficiency of the PGs 102, 104, and FIG. 1C shows the same but with additional rays drawn that arise from imperfect polarization control of the PCS 106, 108. Although FIGS. 1B and 1A are shown separately, in many cases, stray light is caused by both effects.

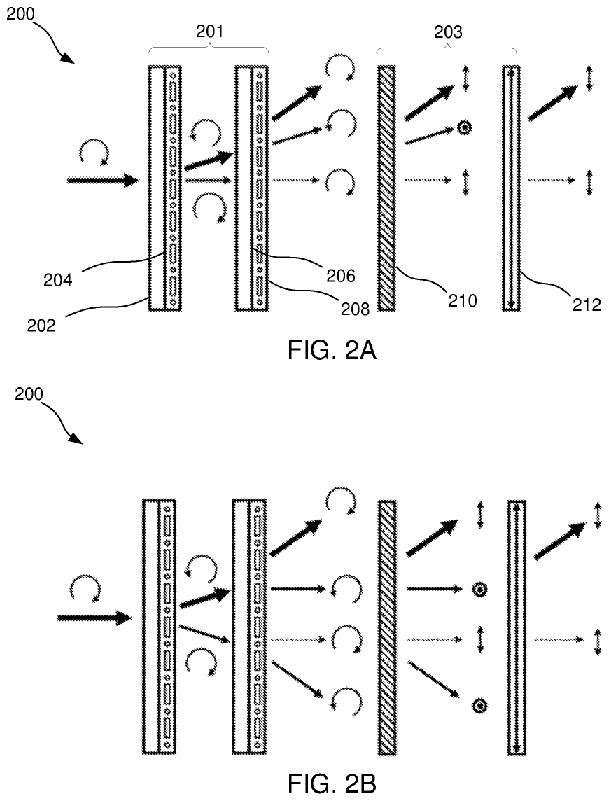

These undesired rays may be predominantly in the orthogonal polarization state to the desired ray and can therefore be eliminated by means of conversion to a linear polarization state and selective absorption or reflection through a polarizer, as shown in FIGS. 2-4. For the purposes of this disclosure, a “polarizer” refers to any component that filters light based on polarization, such as dichroic crystals, doped polymer films, nanoparticle composites, wire grids, prisms, and polarizing beam splitters, to name six non-limiting examples. For instance, a polarizer can filter some but not all linear polarizations of polarized light.

In its simplest embodiment (see FIGS. 2A and 2B), this disclosure uses a retarder providing net retardance of a quarter wave or three-quarter wave retardance to convert the circularly polarized output of the beam steering assembly to linearly polarized light followed by a linear polarizer that can then block the now linearly-polarized unwanted stray light while allowing the desired light orthogonal thereto to pass. The retarder can be a fixed retarder or a variable retarder, to name two non-limited examples.

In FIG. 2A a non-mechanical beam steering assembly 200 includes a first pair or stage including a first PCS 202 and a first PG 204 in front of a second pair or stack of a second PCS 206 and a second PG 208. The first and second PCS components 202, 206 can selectively control a handedness of circularly-polarized light that leaves them. This in turn controls an amount of beam steering that each succeeding PG 204, 208 performs on the beam that leaves the preceding PCS component 202, 206. These two stages can be referred to as a beam steering assembly 201, since subsequent components in the optical assembly 200 are not intended to perform steering, but rather attenuation. The beam steering assembly 201 can include two or more stages, where each stage comprises a PCS component 202, 206 and a PG 204, 208. Although only two stages are shown in the embodiments of this disclosure, any two or more stages can make up the beam steering assemblies disclosed herein. Control of the PCS components 202, 206 means that the first and second PGs 204, 208 of the beam steering assembly 201 can direct light into multiple output angles.

It can be seen that each PCS-PG pair or stage creates a stronger (heavy arrow) desired output beam and a weaker (narrower arrow) undesired or stray beam having opposite polarity to that of the desired beam. This stray beam can be caused by poor diffraction efficiency. So, the first PCS-PG pair, 202, 204 creates a left-hand circularly polarized beam of desired light and a right-hand circularly polarized beam of stray light having less intensity than the desired beam. The second stage, 206, 208 generates a right-hand circularly polarized beam of desired light, and two different polarizations of stray light (light-weight arrow and dashed-line arrow). First a left-hand circularly polarized beam of stray light having less intensity than the desired beam (light-weight arrow), and second a right-hand circularly polarized beam of stray light having less intensity than the left-hand circularly polarized beam of stray light (dashed-line arrow).

To address these stray light beams, an attenuation assembly 203, comprising a retarder 210 (or any polarization controller) and a linear polarizer 212 can be implemented after the beam steering assembly 201. In particular, the retarder 210, in this case a quarter wave retarder (or any retarder with a net quarter wave or three quarters wave retardance), is arranged after the second stage 206, 208. The retarder 210 can be selected to have a retardance that turns the circularly-polarized light that leaves the beam steering assembly 201 into linearly-polarized light. In this embodiment, the retarder 210 is a quarter wave plate and is oriented such that the right-hand circularly polarized desired beam is converted to vertical polarization, the left-hand circularly polarized stray light is converted to horizontal polarization (into the page), and the right-hand circularly polarized stray beam is converted to vertical polarization. A linear polarizer 212 is arranged after the retarder 210 and is oriented to block one of the two linearly-polarized stray light beams. Since the more intense of the two stray light beams is horizontally oriented in this example and the desired beam is vertically oriented, the linear polarizer 212 can be oriented to block horizontal polarization, thereby removing the more intense of the two stray light beams and allowing through the desired vertically-oriented linearly polarized beam. It is true that the vertically-oriented stray beam will also pass through the linear polarizer 212, but since the intensity of this stray beam is much smaller, it is an acceptable compromise. Similarly, the horizontally-polarized stray beam may not be perfectly orthogonal to the desired beam or may not be perfectly linear (i.e., it could be somewhat elliptical). In these cases, the linear polarizer 212 may not completely remove the horizontally-polarized stray light beam, but will remove a significant portion thereof. Because of these imperfections, it can be said that the attenuation assembly 203 constitutes a means to control and filter polarization of emitted light from the beam steering assembly 201 such that a ratio of emitted light in one angle relative to emitted light in all other angles is increased.

Although not shown, the PCS components 202, 206 can be electrically coupled to one or more controllers configured to provide controlling voltage to control the PCS components 202, 206. In some embodiments, the attenuation assembly 203 can be passive/static.

It will be appreciated that FIG. 2A is illustrative only, and many aspects of the assembly 200 can be modified while still achieving the disclosed attenuation of stray light. For instance, while two stages are shown, three or more pairs could also be used. A number of possible (discrete) steering angles scales exponentially (for example, 2^{N}) with the number, N, of stages. A greater number of stages would lead to a greater number of different stray light beams, but at least half of the stray light beams can be blocked by an attenuation assembly such as combination of a retarder and a linear polarizer. As another example, the retarder 210 can take the form of any component that turns circularly-polarized light into linearly-polarized light. For instance, a three-quarter wave plate would be similarly effective as a quarter wave plate, and for that matter, any retarder having a N(¼) wave retardance would be effective (where N is a positive odd integer). Additionally, multiple retarders can be stacked as long as the outcome is a net quarter wave or three-quarter wave retardance. For instance, a half wave plate and a quarter wave plate could be stacked and used as the retarder 210 in FIG. 2A. Further, while FIG. 2A shows incident right-hand circularly polarized light, the disclosure is equally applicable to incident left-hand circularly polarized light. The size of the components and distance between them can be varied without departing from the spirit, scope, and effect of this disclosure. Although FIG. 2A is described relative to beam steering, in other embodiments, the steering assembly 201, or a segmented version thereof, could be designed to achieve lensing (i.e., focus or defocus).

FIG. 2B is structurally identical to FIG. 2A, but also shows stray light caused by poor polarization control. In practice, a combination of the stray light shown in FIG. 2A and 2B could be experienced, and the attenuation assembly 203 could mitigate stray light due to both diffraction efficiency and imperfect PCS polarization control.

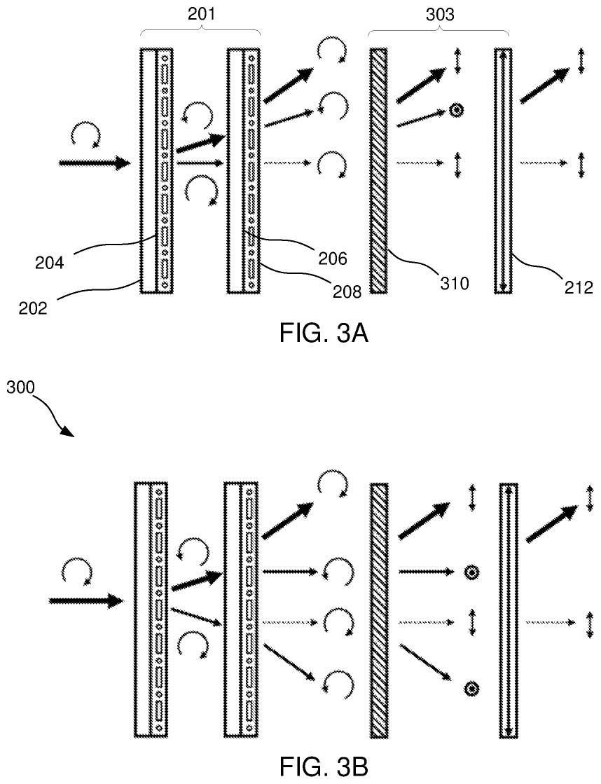

While a retarder 210 has been described as being arranged before the polarizer 212, in some embodiments, a variable retarder can be used. For instance, in FIG. 3A, a variable retarder 310 can be used in place of the retarder 210 in FIGS. 2A and 2B. Such a variable retarder 310 can take the form of a PCS that can provide variable retardance (e.g., a liquid crystal variable retarder). The variable retarder 310 can still convert the circularly polarized output of the beam steering assembly 201 to linearly polarized light, followed by a linear polarizer 212 aligned to transmit the desired ray while blocking orthogonally polarized light. In other words, FIG. 3A mimics FIG. 2A except that the retarder is implemented as a variable retarder 310. This could be desirable where the beam steering assembly 201 is configured to produce a varying polarization in the desired output beam (structure for achieving this variance is not shown, but will be apparent to those of skill in the art). In this embodiment, the variable retarder 310 could be controlled to provide either a quarter wave or three quarters wave retardance (or any odd multiple of a quarter wave retardance). As the beam steering assembly 201 alters the handedness of circular light leaving the beam steering assembly 201, the variable retarder 310 can be correspondingly altered to ensure that the desired linearly-polarized light continues to pass through the linear polarizer 212. In other words, the variable retarder 310 and its use of dynamic switching of retardance can be used, for example, to maintain a constant linear polarization state on the polarizer for different states of the beam steering assembly. Were a fixed retarder used, it is possible that changes in the beam steering assembly 201 could cause the desired beam to be attenuated by the linear polarizer 212.

FIG. 3B is structurally identical to FIG. 3A, but also shows stray light caused by poor polarization control. In practice, a combination of the stray light shown in FIG. 3A and 3B could be experienced, and the attenuation assembly 303 could mitigate stray light due to both diffraction efficiency and imperfect PCS polarization control.

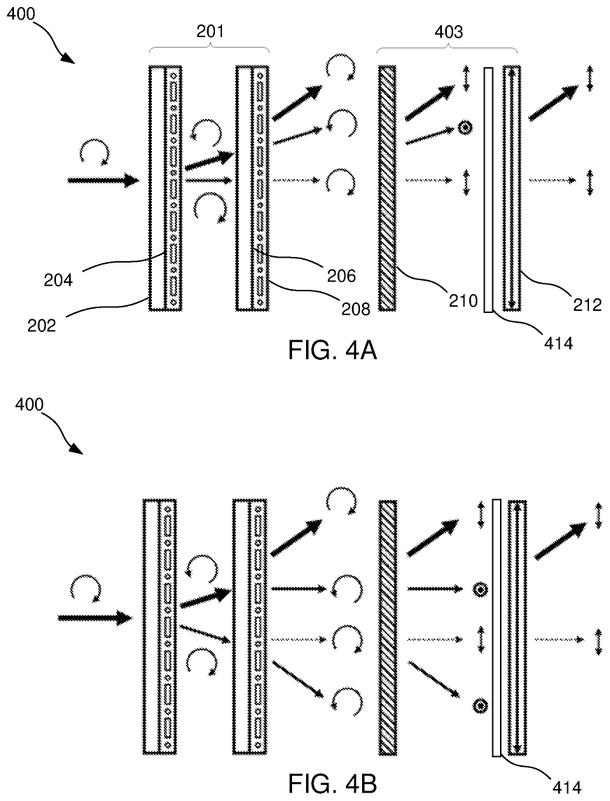

In an alternative to the embodiment shown in FIG. 3A and 3B, the optical assembly 200 of FIGS. 2A and 2B can be used, including the retarder 210, but with a polarization rotator, such as a rotatable half wave retarder, used to optionally rotate the linear polarization emanating from the retarder 210 by 90 degrees prior to the light entering the polarizer 212. For instance, see FIGS. 4A and 4B for an optical assembly 400 using a polarization rotator 414 between the retarder 210 and the linear polarizer 212. This variation would also serve to enable polarization filtering of multiple steering states of the beam steering assembly 201 with a static polarizer. In this embodiment, the retarder 210 and the polarizer 212 are passive/static components.

FIG. 4B is structurally identical to FIG. 4A, but also shows stray light caused by poor polarization control. In practice, a combination of the stray light shown in FIG. 4A and 4B could be experienced, and the attenuation assembly 403 could mitigate stray light due to both diffraction efficiency and imperfect PCS polarization control.

Although this disclosure has described light propagating from left to right in the figures, it is well-understood by those of skill in the art, that the illustrated optical systems have reciprocal functionality and can therefore also operate with light incident from right to left in the figures. More specifically, the PCS components do not have to be upstream of the PG components that they are paired with, but rather the PCS can be arranged on either side of a PG relative to the direction of light. This also means that any of the disclosed embodiments can also be used in applications where light transmits through the stack in a first direction and returns through the stack in an opposing direction. This may be applicable to certain LIDAR applications, as just one example. Such situations would see even greater stray light and thus even more benefit from the solutions disclosed herein.

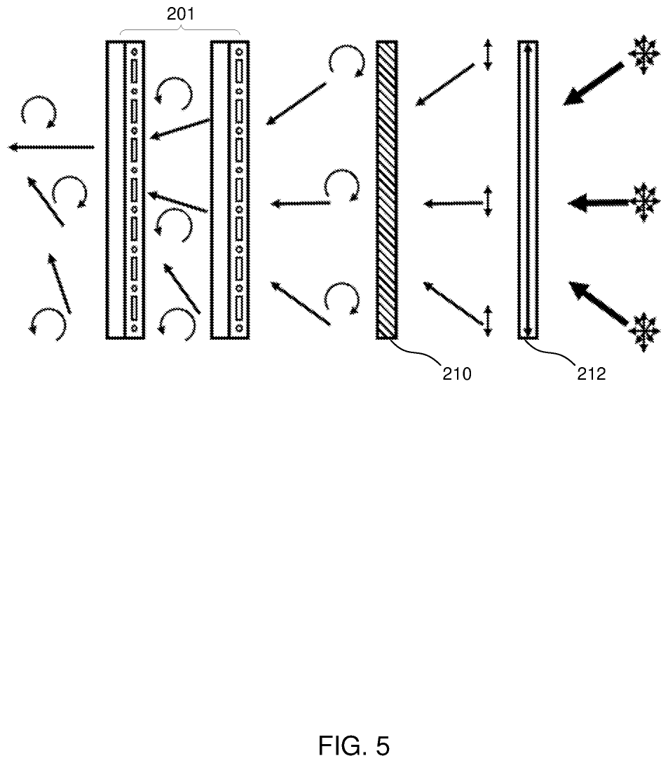

Along these lines, FIG. 5 presents an example of light returning back through the optical assembly 500, for instance, in a LIDAR application. This figure does not show the initial left to right transmission, though one can refer to FIGS. 2A, 2B, 3A, and 3B for examples of this initial propagation. The illustrated return light scattering off objects to the right of the linear polarizer 212 is filtered into linear polarization, then converted to right-hand circular polarized light by the retarder 210, enters the beam steering assembly 201 and the angle of propagation is then shaped accordingly by the stages. The light then exits the assembly to the left at a desired angle.

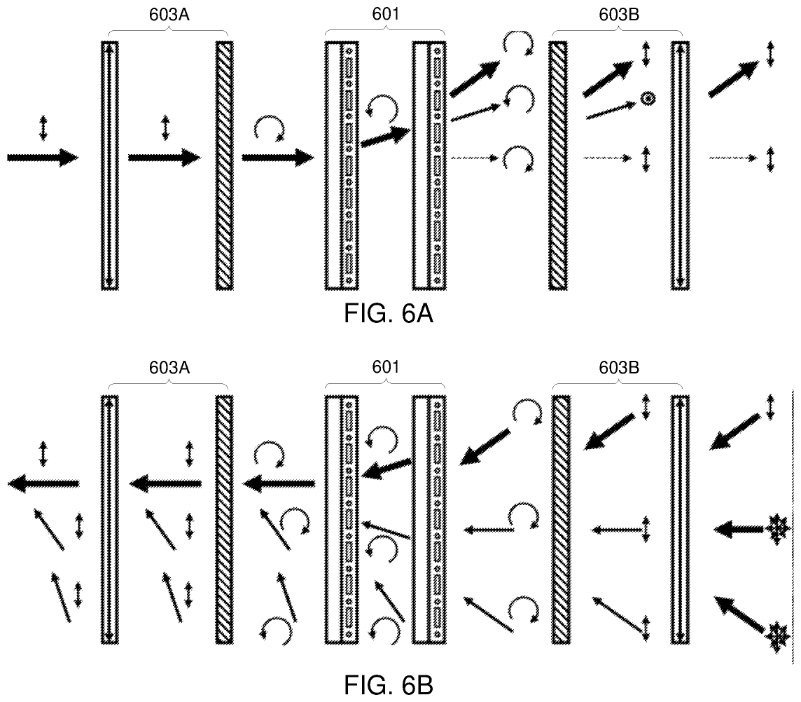

It should also be appreciated that in bidirectional applications, such as certain LIDAR use cases, the polarization control and filtering can be used on both sides of the beam steering assembly. For instance, FIGS. 6A and 6B show opposing polarization control and filtering sections 603A and 603B on either side of a beam steering assembly 601. FIG. 6A shows stray light and filtering for a transmit direction and FIG. 6B shows stray light and filtering for a receive direction after scattering off object(s) of the transmit beam. Light incident on the assembly in the transmit direction can be polarized while scattered light incident on the assembly 600 can be unpolarized. In the transmit direction, the polarization control and filtering sections 603A and 603B preferentially transmit light predominantly in one direction (or focal plane, when the beam steering assembly 601 is primarily for focusing/defocusing). In the receive direction, the polarization control and filtering sections 603A and 603B preferentially receive light predominantly from one direction (or focal plane, when the beam steering assembly 601 is primarily for focusing/defocusing). Light from other directions is not delivered to an imaging sensor, or other receiving device, along the original optical axis. While the beam steering assembly 601 is shown with the PCS components preceding the PG components for the transmit direction, the opposite orientation could also be used.

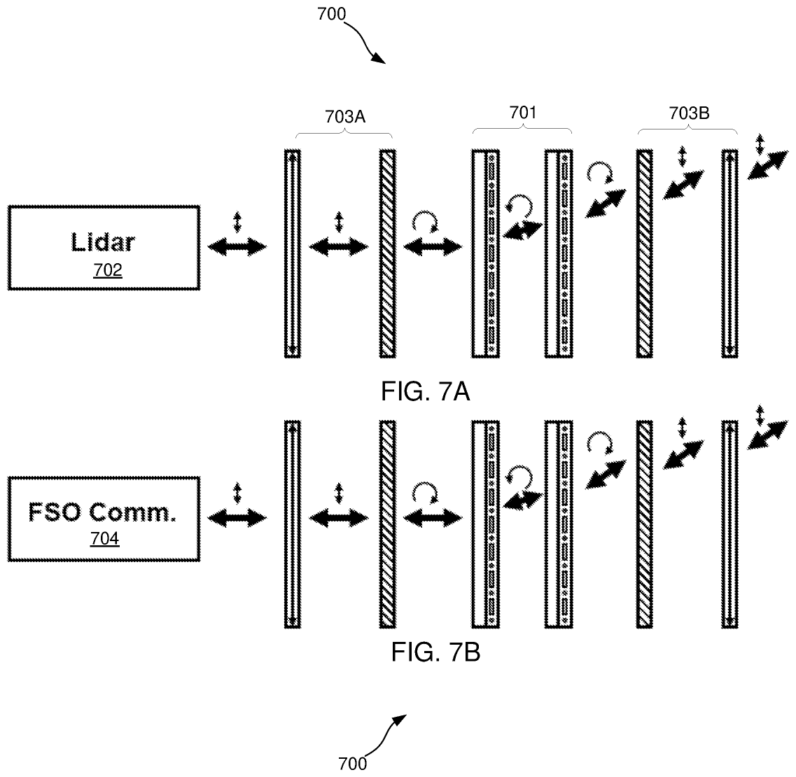

This system having a polarization controller and filtering on opposing sides of the beam steering assembly can be used in conjunction with sensor systems and optical communication system. For instance, FIG. 7A shows a LIDAR application where the optical assembly 700 performs both transmission from the LIDAR source/sensor 702 as well as reception of the returning signal to the LIDAR source/sensor 702. The polarization control and filtering sections 703A and 703B reduce the presence of spurious lidar returns in the desired lidar signal, enhancing the signal to noise ratio. In another example, FIG. 7B shows the same optical system 700 performing transmission from a free space optical (FSO) communication terminal 704 as well as reception of a signal in the opposing direction being received by the FSO communication terminal 704. In this context, the polarization control and filtering sections 703A and 703B reduce the presence of channel crosstalk from downrange communication terminals. These are just two non-limiting use cases to help illustrate the plethora of applications of a bidirectional optical assembly 700. Although only two stages are shown in the beam steering assembly 701, this should not be seen as limiting, but rather than number of two or more stages can be implemented without departing from the scope of this disclosure.

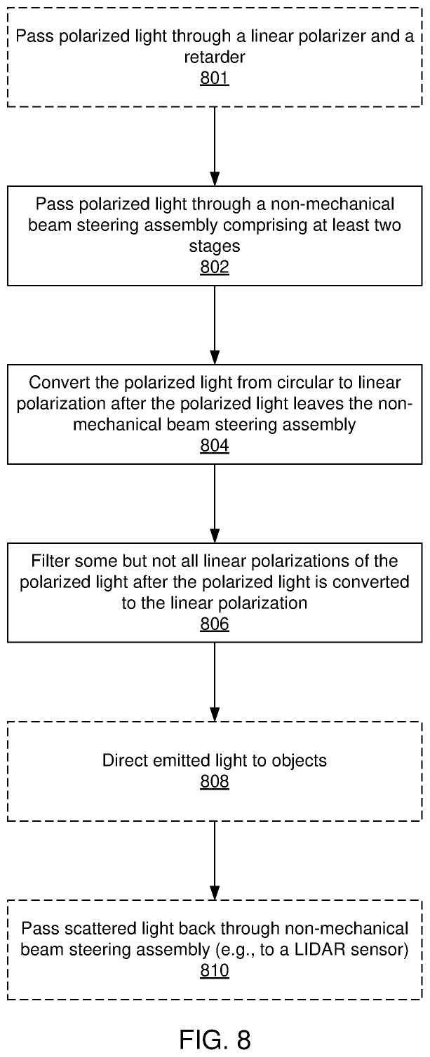

FIG. 8 illustrates a method of filtering stray light in a non-mechanical beam steering optical assembly. The method 800 can include passing polarized light through a non-mechanical beam steering assembly comprising at least two stages (Block 802). Optionally, the polarized light can first be passed through a linear polarizer and a retarder before the polarized light pass through the beam steering assembly (optional Block 801). Each of the at least two stages can include a polarization-controlling switch (PCS) and a polarization grating (PG). The method 800 can include converting the polarized light from circular to linear polarization after the polarized light leaves the non-mechanical beam steering assembly (Block 804). The method 800 can further include filtering some but not all linear polarizations of the polarized light after the polarized light is converted to the linear polarization (Block 806). In some case, the emitted light can be directed to objects, for instance in a LIDAR application, and scattering the polarized light having the linear polarization off of one or more of the objects to form scattered light (optional Block 808). The scattered light can be passed back through the non-mechanical beam steering assembly, for instance, to a LIDAR sensor (optional Block 810).

The reverse process can also be implemented, for instance, a method of filtering wherein the method includes first filtering light to linearly polarized light, converting the linearly polarized light to circularly polarized light, and passing the circularly polarized light through a non-mechanical beam steering assembly. The non-mechanical beam steering assembly can comprise at least two stages, each stage having a PCS and a PG.

Applications to different wavelengths, especially those outside the visible (e.g., microwave to short wavelengths), are possible merely by adjusting a thickness of the optical components disclosed herein.

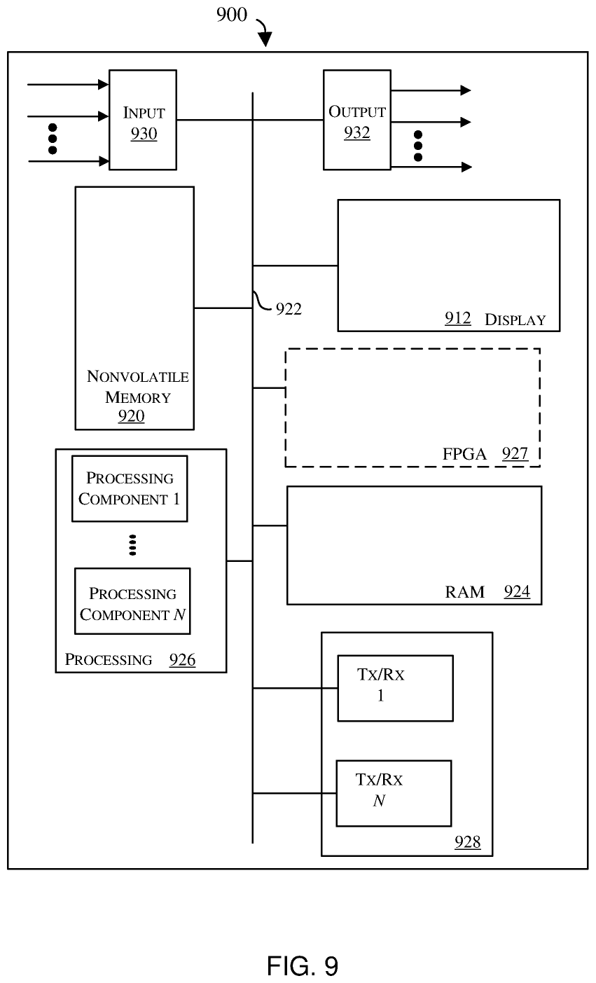

The methods described in connection with the embodiments disclosed herein may be embodied directly in hardware, in processor-executable code encoded in a non-transitory tangible processor readable storage medium, or in a combination of the two. Referring to FIG. 9 for example, shown is a block diagram depicting physical components that may be utilized to realize a controller of the beam steering assembly 201, 601, 701 and the polarization control and filtering section 203, 303, 403, 603A, 603B, 703A, 703B according to an exemplary embodiment. As shown, in this embodiment a display portion 912 and nonvolatile memory 920 are coupled to a bus 922 that is also coupled to random access memory (“RAM”) 924, a processing portion (which includes N processing components) 926, an optional field programmable gate array (FPGA) 927, and a transceiver component 928 that includes N transceivers. Although the components depicted in FIG. 9 represent physical components, FIG. 9 is not intended to be a detailed hardware diagram; thus many of the components depicted in FIG. 9 may be realized by common constructs or distributed among additional physical components. Moreover, it is contemplated that other existing and yet-to-be developed physical components and architectures may be utilized to implement the functional components described with reference to FIG. 9.

This display portion 912 generally operates to provide a user interface for a user, and in several implementations, the display is realized by a touchscreen display. In general, the nonvolatile memory 920 is non-transitory memory that functions to store (e.g., persistently store) data and processor-executable code (including executable code that is associated with effectuating the methods described herein). In some embodiments for example, the nonvolatile memory 920 includes bootloader code, operating system code, file system code, and non-transitory processor-executable code to facilitate the execution of a method described with reference to FIG. 8 described further herein.

In many implementations, the nonvolatile memory 920 is realized by flash memory (e.g., NAND or ONENAND memory), but it is contemplated that other memory types may be utilized as well. Although it may be possible to execute the code from the nonvolatile memory 920, the executable code in the nonvolatile memory is typically loaded into RAM 924 and executed by one or more of the N processing components in the processing portion 926.

The N processing components in connection with RAM 924 generally operate to execute the instructions stored in nonvolatile memory 920 to enable stray light reduction in a non-mechanical beam steering system. For example, non-transitory, processor-executable code to effectuate the methods described with reference to FIG. 8 may be persistently stored in nonvolatile memory 920 and executed by the N processing components in connection with RAM 924. As one of ordinarily skill in the art will appreciate, the processing portion 926 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 926 may be configured to effectuate one or more aspects of the methodologies described herein (e.g., the method described with reference to FIG. 8). For example, non-transitory processor-readable instructions may be stored in the nonvolatile memory 920 or in RAM 924 and when executed on the processing portion 926, cause the processing portion 926 to perform a method for stray light reduction in a non-mechanical beam steering system. Alternatively, non-transitory FPGA-configuration-instructions may be persistently stored in nonvolatile memory 920 and accessed by the processing portion 926 (e.g., during boot up) to configure the hardware-configurable portions of the processing portion 926 to effectuate the functions of the controller of the optical assemblies disclosed herein.

The input component 930 operates to receive signals (e.g., control signals or feedback signals) that are indicative of one or more aspects of the desired beam steering. The signals received at the input component may include, for example, feedback from an imaging sensor downrange from the polarizer output. The output component generally operates to provide one or more analog or digital signals to effectuate an operational aspect of the controller. For example, the output portion 932 may provide the control signals to the beam steering assembly 201, 601, 701 and the polarization control and filtering section 203, 303, 403, 603A, 603B, 703A, 703B.

The depicted transceiver component 928 includes N transceiver chains, which may be used for communicating with external devices via wireless or wireline networks. Each of the N transceiver chains may represent a transceiver associated with a particular communication scheme (e.g., WiFi, Ethernet, Profibus, etc.).

The foregoing is illustrative of the present disclosure and is not to be construed as limiting thereof. Although a few exemplary embodiments of this disclosure have been described, those skilled in the art will readily appreciate that many modifications are possible in the exemplary embodiments without materially departing from the novel teachings and advantages of this disclosure. For example, the illustrations show the polarization options being added directly down the optical path from the beam steering assembly 201. However, it should be clear that the polarization optics could be physically mounted to the beam steering assembly 201, could be mounted separately, and could be mounted such that there are intermediate optics between the beam steering assembly 201 and the polarization optics so long as the function of the polarization optics is to selectively transmit the desired rays while preferentially blocking undesired rays. As another example, the illustrations describe retarder optics with specific retardances such as “quarter wave” or “three quarter wave”. It should be understood that any net quarter wave retardance will be effective and that retarders providing more than one wave, such as multi-order retarders, are functionally equivalent.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms-even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding”-whether explicitly discussed or not-and, conversely, were there only disclosure of the act of “protruding”, such a disclosure should be understood to encompass disclosure of a “protrusion”. Such changes and alternative terms are to be understood to be explicitly included in the description.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An optical assembly for non-mechanical light angle alteration and filtering of stray light, the optical assembly comprising:
a beam steering assembly comprising:
a first polarization-controlling switch;
a first polarization grating;
a second polarization-controlling switch;
a second polarization grating; and
a first means to control and filter polarization of light entering or leaving the beam steering assembly such that a ratio of emitted light in one angle to emitted light in all other angles of the emitted light is increased.

2. The optical assembly of claim 1, wherein the first means to control and filter comprises a retarder.

3. The optical assembly of claim 2, wherein the retarder is a fixed retarder having a net quarter wave or three-quarter wave retardance.

4. The optical assembly of claim 3, wherein the first means to control and filter comprises a linear polarizer arranged after the fixed retarder.

5. The optical assembly of claim 4, further comprising a polarization rotator between the fixed retarder and the linear polarizer.

6. The optical assembly of claim 2, wherein the retarder is a variable retarder.

7. The optical assembly of claim 2, wherein the first means to control and filter comprises a linear polarizer arranged after the retarder.

8. The optical assembly of claim 7, further comprising a polarization rotator between the retarder and the linear polarizer.

9. The optical assembly of claim 2, wherein the beam steering assembly comprises one or more additional pairs of a polarization-controlling switch and a polarization grating.

10. The optical assembly of claim 2, wherein the first polarization grating and the second polarization grating direct light into multiple output angles.

11. The optical assembly of claim 2, further comprising a controller configured to provide voltage to either or both of the first and second polarization-controlling switches to thereby control output angles of emitted light.

12. The optical assembly of claim 2, wherein the first polarization-controlling switch is a liquid crystal.

13. The optical assembly of claim 1, further comprising a second means to control and filter polarization of the light entering or leaving the beam steering assembly, the second means to control and filter arranged on an opposing side of the beam steering assembly from the first means to control and filter.

14. A method of filtering stray light in a non-mechanical beam steering optical assembly, the method comprising:
passing polarized light through a non-mechanical beam steering assembly comprising at least two stages, each of the at least two stages comprising a polarization-controlling switch and a polarization grating;
converting the polarized light from circular to linear polarization after the polarized light leaves the non-mechanical beam steering assembly; and
filtering some but not all linear polarizations of the polarized light after the polarized light is converted to the linear polarization.

15. The method of claim 14, wherein a polarizer is used to filter certain linear polarizations of the polarized light.

16. The method of claim 15, wherein a retarder is used to convert the polarized light from circular to linear polarization.

17. The method of claim 14, further comprising passing the polarized light through a linear polarizer and a retarder before the polarized light passes through the non-mechanical beam steering assembly.

18. The method of claim 17, further comprising scattering the polarized light having the linear polarization off of one or more objects to form scattered light, and passing the scattered light back through the non-mechanical beam steering assembly to a LIDAR sensor.

19. A method of filtering stray light in a non-mechanical beam steering optical assembly, the method comprising:
filtering light to linearly polarized light;
converting the linearly polarized light to circularly polarized light; and
passing the circularly polarized light through a non-mechanical beam steering assembly comprising at least two stages, each of the at least two stages comprising a polarization-controlling switch and a polarization grating.

20. The method of claim 19, wherein a polarizer is used to filter the light to the linearly polarized light.

21. The method of claim 20, wherein a retarder is used to convert the linearly polarized light to the circularly polarized light.

22. The method of claim 19, wherein a retarder is used to convert the linearly polarized light to the circularly polarized light.

23. The method of claim 19, further comprising passing the circularly polarized light through a retarder and a linear polarizer after the circularly polarized light passes through the non-mechanical beam steering assembly.

24. The method of claim 19, further comprising scattering the circularly polarized light, after it leaves the non-mechanical beam steering assembly, off of one or more objects to form scattered light, and passing the scattered light back through the non-mechanical beam steering assembly to a LIDAR sensor.
